(19) United States
(12) Patent Application Publication
(10) Pub. No.: US 2026/0290394 A1
(43) Pub. Date: Sep. 24, 2026

(54) DISK DEVICE AND CONTROL METHOD FOR DISK DEVICE

(71) Applicants: KABUSHIKI KAISHA TOSHIBA, Kawasaki-shi (JP); TOSHIBA ELECTRONIC DEVICES & STORAGE CORPORATION, Kawasaki-shi (JP)

(72) Inventor: Keigo SOGABE, Chigasaki Kanagawa (JP)

(73) Assignees: KABUSHIKI KAISHA TOSHIBA, Kawasaki-shi (JP); TOSHIBA ELECTRONIC DEVICES & STORAGE CORPORATION, Kawasaki-shi (JP)

(21) Appl. No.: 19/372,815

(22) Filed: Oct. 29, 2025

(30) Foreign Application Priority Data
Mar. 24, 2025 (JP) 2025-048014

(51) Int. Cl. G11B 19/04; G11B 5/82; G11B 5/86

(52) U.S. Cl. CPC G11B 19/044; G11B 5/86; G11B 19/048; G11B 5/82

(57) ABSTRACT

According to one embodiment, disk device including a nonvolatile memory and a controller is provided. The nonvolatile memory includes a storage area and a management information storage area. The storage area includes multiple access units. The management information storage area stores defect management information. The controller is accessible to the nonvolatile memory. The controller is configured to execute alternative processing by re-assigning data to another access unit and rewriting data originally assigned to a defective access unit among the multiple access units.

### CROSS-REFERENCE TO RELATED APPLICATIONS

This application is based upon and claims the benefit of priority from Japanese Patent Application No. 2025-048014, filed on Mar. 24, 2025; the entire contents of which are incorporated herein by reference.

### FIELD

Embodiments described herein relate generally to a disk device and a control method for a disk device.

### BACKGROUND

In a disk device including a nonvolatile memory and a controller, when the controller writes data in a storage area of the nonvolatile memory, in some case, a write error occurs and the data is rewritten. In the disk device, it is desired to efficiently rewrite data.

### BRIEF DESCRIPTION OF THE DRAWINGS

FIG. 1 is a diagram illustrating a configuration of a disk device according to an embodiment;

FIG. 2 is a diagram illustrating a configuration of a nonvolatile memory in the embodiment;

FIG. 3 is a diagram illustrating a configuration of a memory cell array in the embodiment;

FIG. 4 is a waveform diagram illustrating a schematic operation of the disk device according to the embodiment;

FIG. 5 is a flowchart illustrating a detailed operation of the disk device according to the embodiment;

FIG. 6 is a diagram illustrating a data structure of logical-physical conversion information in the embodiment;

FIGS. 7A and 7B are diagrams illustrating a data structure of alternative management information in the embodiment;

FIG. 8 is a flowchart illustrating alternative processing in the embodiment;

FIGS. 9A and 9B are diagrams illustrating use cases of alternative processing in a modification of the embodiment;

FIGS. 10A and 10B are diagrams illustrating use cases of the alternative processing in the modification of the embodiment; and

FIGS. 11A to 11C are diagrams illustrating use cases of the alternative processing in the modification of the embodiment.

### DETAILED DESCRIPTION

In general, according to one embodiment, a disk device including a nonvolatile memory and a controller is provided. The nonvolatile memory includes a storage area and a management information storage area. The storage area includes multiple access units. The management information storage area stores defect management information. The controller is accessible to the nonvolatile memory. The controller is configured to execute alternative processing by re-assigning data to another access unit and rewriting data originally assigned to a defective access unit among the multiple access units.

Exemplary embodiments of a disk device will be explained below in detail with reference to the accompanying drawings. The present invention is not limited to the following embodiments.

### EMBODIMENT

The disk device according to the embodiment includes a nonvolatile memory and a controller, and the controller writes data in a storage area of the nonvolatile memory. However, a device is applied to efficiently rewrite data when a write error occurs.

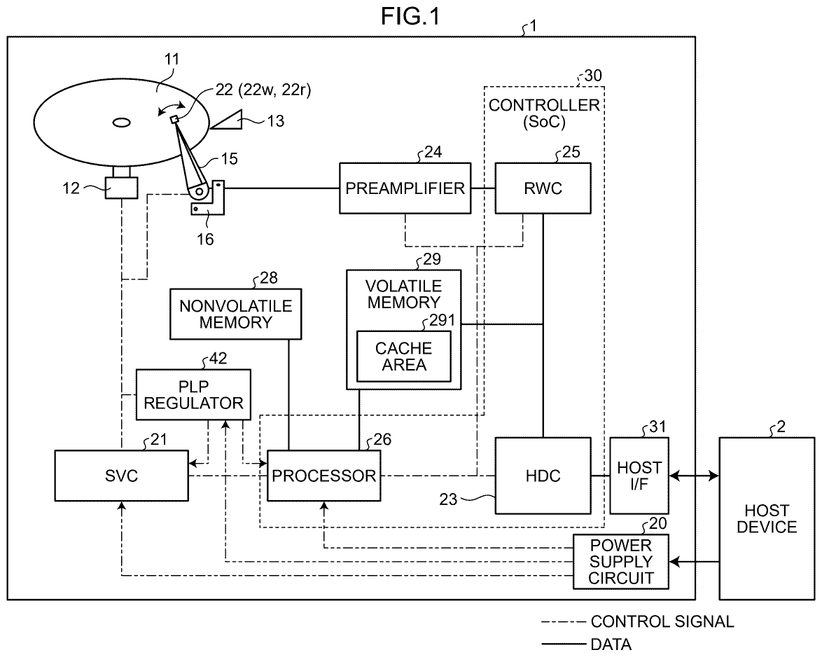

A disk device 1 can be configured as illustrated in FIG. 1. FIG. 1 is a diagram illustrating a configuration of the disk device 1.

The disk device 1 can be communicably connected to a host 2 via a communication medium. The disk device 1 is connected to the host 2 via a communication medium and functions as an external storage medium for the host 2. The communication medium may be a serial communication line. The host 2 is, for example, an information terminal such as a computer.

The disk device 1 includes a disk medium 11, a spindle motor (SPM) 12, a ramp 13, an actuator arm 15, a voice coil motor (VCM) 16, a power supply circuit 20, a servo controller (SVC) 21, a head 22, a host interface (host I/F) 31, a preamplifier 24, a nonvolatile memory 28, a volatile memory 29, a power loss protection (PLP) regulator 42, and a controller 30.

The controller 30 integrally controls the units of the disk device 1. The controller 30 includes a hard disk controller (HDC) 23, a read write channel (RWC) 25, and a processor 26. The controller 30 may be configured by a system-on-a-chip (SoC).

The disk medium 11 is a disk-type storage medium and may be a magnetic disk or may be a magneto-optical disk. In a case where the disk medium 11 is a magnetic disk, a magnetic layer is formed on a surface of the magnetic disk and information can be recorded in a magnetization direction.

The disk medium 11 is rotatably supported by a housing (not illustrated) of the disk device 1 via the SPM 12.

The power supply circuit 20 distributes electric power supplied from the host 2 to the components of the disk device 1 as indicated by an arrow of an alternate long and two short dashes line in FIG. 1. As a power supply destination by the power supply circuit 20, in FIG. 1, the SVC 21, the processor 26, and the PLP regulator 42 are exemplified. However, electric power may be further supplied to other components from the power supply circuit 20. The power supply circuit 20 may convert a voltage according to a power supply destination. Note that the power supply circuit 20 may receive power supply from a power supply device or from a system instead of the host 2.

The SVC 21 functions as a driver that drives the SPM 12 and the VCM 16. The SVC 21 may be configured by an integrated circuit.

The head 22 writes information in and reads information from the disk medium 11 with a write element 22w and a read element 22r provided in the head 22. The head 22 is attached to the distal end of the actuator arm 15. The head 22 is moved in the radial direction of the disk medium 11 by the VCM 16 driven by the SVC 21. Note that one or both of the write element 22w and the read element 22r provided in the head 22 may be provided in plurality for a single head 22.

For example, when the rotation of the disk medium 11 is stopped, the head 22 is moved onto the ramp 13. The ramp 13 is configured to hold the head 22 at a position spaced apart from the disk medium 11.

The preamplifier 24 writes and reads data via the head 22. The preamplifier 24 may be configured by an integrated circuit. At a read operation time, the preamplifier 24 amplifies and outputs a signal read from the disk medium 11 by the head 22 and supplies the amplified signal to the RWC 25. At a write operation time, the preamplifier 24 amplifies a signal corresponding to write target data supplied from the RWC 25 and supplies the amplified signal to the head 22.

The nonvolatile memory 28 stores information in a nonvolatile manner. The nonvolatile memory 28 includes a memory cell array 117. The memory cell array 117 includes a storage area 28a and a management information storage area 28b. Data can be stored in the storage area 28a of the memory cell array 117. In the management information storage area of the memory cell array 117, management information such as firmware (program data) and various operation parameters can be stored. The firmware may be stored in a management information storage area of the disk medium 11 instead of the nonvolatile memory 28. The nonvolatile memory 28 includes a serial NAND flash memory.

The volatile memory 29 is used as a buffer for data transmitted to and received from the host 2. That is, a cache area 291 is allocated to the volatile memory 29, and the volatile memory 29 functions as a cache memory. The cache area 291 is used to temporarily store write target data that has not yet been written in the disk medium 11 among data received from the host 2. The volatile memory 29 is used to temporarily store data read from the disk medium 11.

The volatile memory 29 is used as a memory for operation by the processor 26. The volatile memory 29 is used as an area in which firmware is loaded and an area in which various kinds of management data are temporarily stored. The volatile memory 29 may be a dynamic random access memory (DRAM).

A nonvolatile memory 28 and a volatile memory 29 are connected to the processor 26. When firmware is read from the nonvolatile memory 28 or the management information storage area of the disk medium 11, the processor 26 performs overall control for the disk device 1 according to the firmware.

For example, the processor 26 loads the firmware from the nonvolatile memory 28 or the disk medium 11 in the volatile memory 29 and executes control for the SVC 21, the preamplifier 24, the RWC 25, the HDC 23, and the like according to the firmware loaded in the volatile memory 29. The processor 26 controls to rotate the SPM 12 via the SVC 21. The processor 26 controls driving of the VCM 16 via the SVC 21. The processor 26 may include a central processing unit (CPU).

The host I/F 31 is connectable to the host 2 via a communication medium. The host I/F 31 functions as a communication interface with the host 2.

The HDC 23 performs, for example, control of transmission and reception of data performed with the host 2 via the host I/F 31 and control of the volatile memory 29.

For example, the processor 26 reads logical-physical conversion information 32 and 33 and defect management information 34 and 35 from the nonvolatile memory 28 or the management information storage area of the disk medium 11 at a start time or the like of the disk device 1 and stores the logical-physical conversion information 32 and 33 and the defect management information 34 and 35 in the cache area 291.

The logical-physical conversion information 32 is information in which a logical address and a physical address of the disk medium 11 are associated with each other. The logical-physical conversion information 32 may have a table format data structure. The logical address is a logical address included in an access request and can be designated by the host 2.

The physical address of the disk medium 11 is a physical address indicating a storage place in the disk medium 11 and can be allocated by the processor 26. The physical address includes, for example, a combination of a cylinder number and a sector number. The cylinder number is a number for identifying a cylinder. The cylinder is a unit of a storage area extending over multiple tracks corresponding to the top to the bottom in multiple disk media 11. The sector number is information for identifying a sector position in one track.

That is, the physical address is continuously allocated to, for a part of the information, respectively in the tracks and for each of multiple tracks adjacent in the disk medium 11. Note that the physical address includes a head number (a recording surface number) and can be consecutively allocated to multiple tracks vertically adjacent in the cylinder.

The logical-physical conversion information 33 is information in which a logical address and a physical address of the nonvolatile memory 28 are associated. The logical-physical conversion information 33 may have a table format data structure. The logical address is a logical address included in an access request and can be designated by the host 2.

The physical address of the nonvolatile memory 28 is a physical address indicating a storage place in the nonvolatile memory 28 and can be allocated by the processor 26. The physical address includes, for example, a memory package number, a memory die number, a block address, a page address, and a position in a page.

The defect management information 34 is information for managing a physical address of the disk medium 11 where a write error in the disk medium 11 has been detected. The defect management information 34 may include, as the physical address of the disk medium 11 where the write error has been detected, information for identifying a management unit including a position where the write error has been detected. The management unit of the write error includes a sector. Information (for example, a sector number) for identifying a sector including a physical address of the disk medium 11 where write errors have been detected a predetermined number of times even if the rewrite has been performed may be recorded in the defect management information 34.

The defect management information 35 is information for managing the physical address of the nonvolatile memory 28 where the write error has been detected. The defect management information 35 may include, as the physical address of the nonvolatile memory 28, information for identifying a management unit including a position where a write error has been detected. The management unit of the write error includes, for example, a block. Information (for example, a block address) for identifying a block including a physical address of the nonvolatile memory 28 where write errors have been detected a predetermined number of times even if rewrite has been performed may be recorded in the defect management information 35.

The nonvolatile memory 28 includes multiple memory packages and a controller. Each memory package includes multiple memory dies. Each memory die includes multiple blocks. Each block includes multiple pages. In each memory die, data is written and read in units of pages and data is erased in units of blocks. Each of the memory package number, the memory die number, the block address, the page address, and the position in the page is allocated by the controller in the nonvolatile memory 28. A result of the allocation is notified to the controller 30 of the disk device 1.

It should be noted that a part of a memory area in which memory cell arrays of the multiple memory dies are collected functions as the storage area 28a and another part functions as the management information storage area 28b. Hereinafter, a management unit of a write error managed by the defect management information 35 in the storage area 28a is referred to as defect management unit.

The HDC 23 can receive an access request from the host 2 via the host I/F 31. The access request includes a write request and a read request. The HDC 23 supplies the received access request to the processor 26 and/or the RWC 25.

In a case where the access request is a write request, the processor 26 performs command processing on the write request including a write instruction, a logical address, and write data. In response to the write instruction, the processor 26 registers the logical address included in the write request in the logical-physical conversion information 32. The processor 26 allocates a physical address on the disk medium 11 to the logical address and updates the logical-physical conversion information 32 according to the physical address. Accordingly, the processor 26 completes command processing. When the command processing is completed, the processor 26 accesses a part corresponding to the physical address of the disk medium 11 through the preamplifier 24 and the head 22 and writes the write data.

In a case where the access request is a read request, the processor 26 performs command processing on the read request including the read instruction and the logical address. In response to the read instruction, the processor 26 refers to the logical-physical conversion information 32 on the cache area 291 and acquires the physical address corresponding to a logical address included in the read request. Accordingly, the processor 26 completes command processing. When the command processing is completed, the processor 26 accesses a part corresponding to the physical address of the disk medium 11 through the preamplifier 24 and the head 22 and reads data.

The RWC 25 code-modulates write data stored in the cache area 291 according to a write instruction supplied from the HDC 23 and/or the processor 26 and writes the code-modulated data in the part corresponding to the physical address on the disk medium 11 through the preamplifier 24.

According to a read instruction supplied from the HDC 23 and/or the processor 26, the RWC 25 executes code demodulation including error correction on a signal read from the part corresponding to the physical address on the disk medium 11 and supplied from the preamplifier 24. The RWC 25 outputs the code-demodulated signal to the HDC 23 as digital data.

The disk device 1 operates using electric power from the host 2. However, the supply of the electric power from the host 2 is sometimes cut off. As measures against the cutoff of the power supply, the disk device has a PLP function. The PLP function is a function of protecting the disk device 1 to reduce the influence on the cutoff of the power supply from the host 2.

The PLP regulator 42 is capable of supplying electric power to the SVC 21 and the processor 26 according to the PLP function as indicated by an arrow of an alternate long and two short dashes line in FIG. 1.

In a case where the power supply from the host 2 is cut off, the disk device 1 generates a signal indicating the power supply cutoff and supplies the signal to the PLP regulator 42. The SPM 12 rotates by inertia and can generate regenerative energy with a counter electromotive force by the rotation. The PLP regulator 42 receives the regenerative energy from the SPM 12 in response to the signal indicating the power supply cutoff. Then, the PLP regulator 42 generates electric power based on the regenerative energy and supplies the generated power to the SVC 21 and the processor 26. The PLP regulator 42 may further supply the generated electric power to the other components in the disk device 1.

In the PLP function, in a case where the cutoff of the power supply from the host 2 is detected during writing, data during the writing in the cache area 291 of the volatile memory 29 is saved in a nonvolatile storage area, whereby loss of data from the disk device 1 is prevented.

Here, it is difficult to use the disk medium 11 as the nonvolatile storage area. An amount of the regenerative energy recovered by the PLP regulator 42 is limited because the disk medium 11 rotates using the inertia of the regenerative energy. For that reason, if the disk medium 11 that takes a relatively long time for a write operation is selected as a saving destination, it is likely that data being written cannot be completely saved.

For that reason, as processing of the PLP function, data in the cache area 291 is saved in the nonvolatile memory 28.

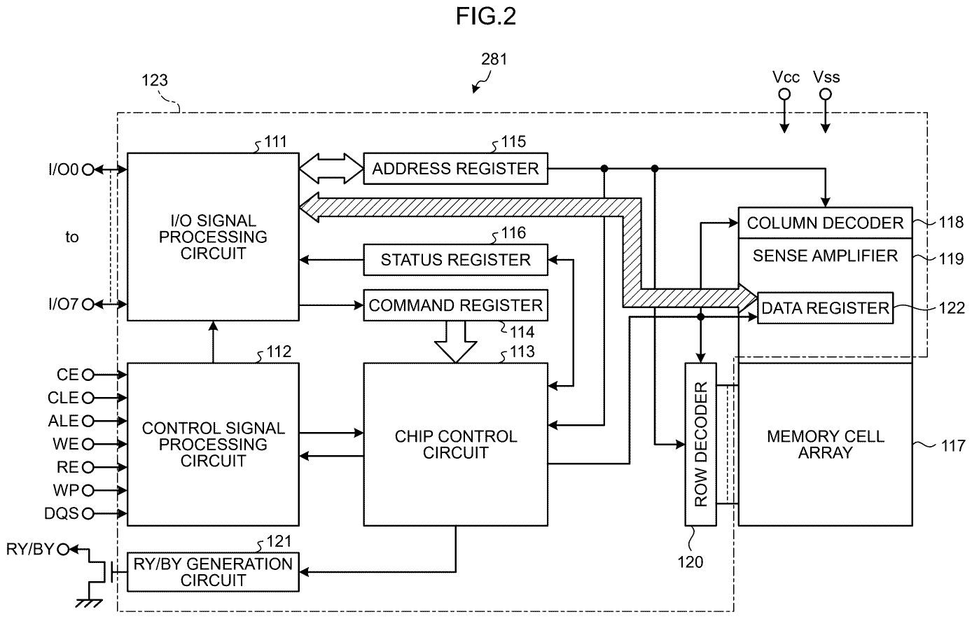

The nonvolatile memory 28 can be configured as illustrated in FIG. 2. FIG. 2 is a diagram illustrating a configuration of the nonvolatile memory 28.

The nonvolatile memory 28 includes multiple memory chips 281. Each memory chip 281 includes a memory cell array 117 and a peripheral circuit 123. The peripheral circuit 123 includes an I/O signal processing circuit 111, a control signal processing circuit 112, a chip control circuit 113, a command register 114, an address register 115, a status register 116, a column decoder 118, a sense amplifier 119, a row decoder 120, and an RY/BY generation circuit 121. The sense amplifier 119 includes a data register 122.

Note that the chip control circuit 113, the sense amplifier 119, and the row decoder 120 are examples of a first circuit. The I/O signal processing circuit 111, the control signal processing circuit 112, and the RY/BY generation circuit 121 are examples of a second circuit.

The control signal processing circuit 112 receives inputs of various control signals and executes, based on the received control signals, distribution to registers of storage destinations of an I/O signal received by the I/O signal processing circuit 111. The control signal processing circuit 112 transfers the received control signals to the chip control circuit 113.

The chip control circuit 113 is a state transition circuit (a state machine) that performs state transition based on various control signals received via the control signal processing circuit 112. The chip control circuit 113 controls an operation of the entire memory chip 281 based on the various control signals. The chip control circuit 113 can generate status information indicating a state of the operation control, a result of the operation control, and the like and store a status information in the status register 116. The chip control circuit 113 can output the status information stored in the status register 116 via the I/O signal processing circuit 111 in response to a status read request from the controller 30 or the like.

The RY/BY generation circuit 121 transitions a state of an RY/BY signal line between a ready state (R) and a busy state B under the control by the chip control circuit 113.

The I/O signal processing circuit 111 is a buffer circuit for transmitting and receiving an I/O signal to and from the controller 30 via an I/O signal line. A command, an address, and data (write data) fetched as I/O signals by the I/O signal processing circuit 111 are respectively distributed to and stored in an address register 115, a command register 114, and a data register 122.

The address stored in the address register 115 includes a row address and a column address. The row address and the column address are respectively read by the row decoder 120 and the column decoder 118.

The memory cell array 117 is configured by arraying NAND type memory cells and stores write data received from a host 200. Specifically, the memory cell array 117 includes multiple physical blocks BLK. All pieces of data stored in one physical block BLK are collectively erased (erased).

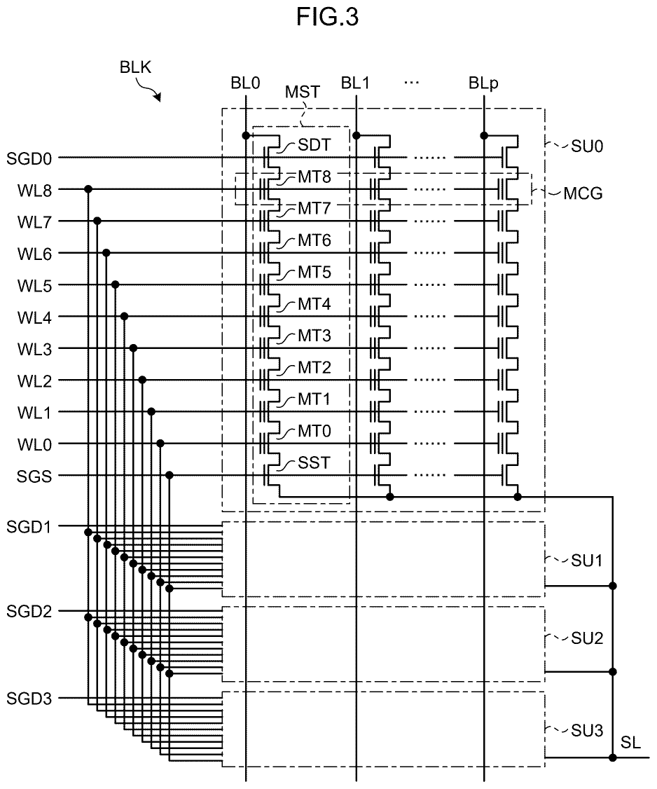

FIG. 3 is a circuit diagram illustrating a configuration of the memory cell array.

Each physical block BLK includes multiple string units SU0 to SU 3. The multiple string units SU0 to SU 3 respectively correspond to multiple select gate lines SGD0 to SGD3. The multiple string units SU0 to SU 3 share a select gate line SGS. The string units SU0 to SU 3 function as a drive unit in the physical block BLK. The string units SU0 to SU 3 can be driven by the select gate lines SGD0 to SGD3 corresponding to the string units SU0 to SU 3 and by the select gate line SGS. Each of the string units SU0 to SU 3 includes multiple memory strings MST.

Each memory strings MST includes, for example, nine memory cell transistors MT (MT0 to MT8) and select transistors SDT and SST. The memory cell transistor MT includes a control gate and a charge storage film and retains data in a nonvolatile manner. The nine memory cell transistors MT (MT0 to MT8) are connected in series by the bit line BL between a source of the select transistor SDT and a drain of the select transistor SST. The number of memory cell transistors MT in the memory string MST is not limited to nine.

Each of word lines WL0 to WL8 (in a case where the word lines are not distinguished, the word lines are indicated by WL) connects control gates of the memory cell transistors MT in common among the memory strings MST in the physical block BLK. That is, in each string unit SU in the physical block BLK, the control gates of the memory cell transistors MT present in the same row are connected to the same word line WL. The string unit SU of the physical block BLK includes multiple memory cell groups MCG respectively corresponding to the multiple word lines WL. Each memory cell group MCG includes (p+1) memory cell transistors MT connected to the same word line WL. In a case where each memory cell transistor MT is configured to be capable of storing a value of one bit (that is, in a case where each memory cell transistor MT operates in a single-level cell (SLC) mode), the memory cell group MCG stores data for one page. In this case, a write operation and a read operation are performed for each data of one page.

Each memory cell transistor MT is sometimes configured to be capable of retaining a value of multiple bits. For example, in a case where each memory cell transistor MT is capable of storing a value of n (n≥2) bits, a storage capacity per memory cell group MCG is equal to a size for n pages. That is, each memory cell group MCG stores data for n pages. In a multi-level cell (MLC) mode in which each memory cell transistor MT stores a value of two bits, data for two pages is stored in each memory cell group MCG. In a triple level cell (TLC) mode in which each memory cell transistor MT stores a value of three bits, data for three pages is stored in each memory cell group MCG. In a quad-level cell (QLC) mode in which each memory cell transistor MT stores a value of four bits, data for four pages is stored in each memory cell group MCG. In a penta-level cell (PLC) mode in which each memory cell transistor MT stores a value of five bits, data for five pages is stored in each memory cell group MCG.

The memory cell array 117 includes multiple units that are accessible in parallel by the controller 30. The controller 30 manages, as one super page, multiple physical pages in which a write operation/a read operation can be performed substantially collectively in parallel and manages, as one super block, multiple physical blocks in which an erase operation can be performed in parallel.

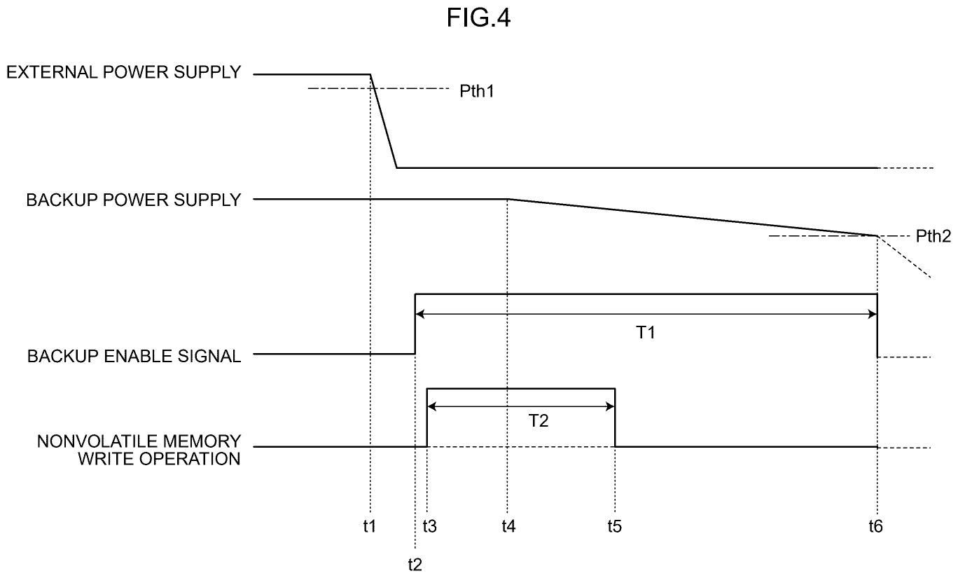

Subsequently, an overview of an operation of the disk device 1 at the time when power supply cutoff occurs is explained with reference to FIG. 4. FIG. 4 is a waveform diagram illustrating a schematic operation of the disk device 1.

When power supply cutoff occurs, the disk device 1 performs an operation conforming to the PLP function (hereinafter, a PLP operation) illustrated in FIG. 4.

For example, at timing t1, the power supply circuit 20 detects that a level of external power supply power from the host 2 drops to be equal to or lower than a threshold Pth1. In response to this, the power supply circuit 20 generates a signal indicating power supply cutoff and supplies the signal to the PLP regulator 42.

At timing t2, the PLP regulator 42 asserts a backup enable signal and supplies the backup enable signal to the SVC 21 and the controller 30 in response to the signal indicating the power supply cutoff. The backup enable signal indicates that data should be backed up (saved) in an asserted state.

At timing t3, the SVC 21 brings the SPM 12 into a regeneration state in response to the backup enable signal in the asserted state. In response to the backup enable signal in the asserted state, the PLP regulator 42 receives regenerative energy from the SPM 12, generates electric power based on the regenerative energy, and supplies the generated electric power to the SVC 21 and the processor 26 as backup power supply power. The controller 30 reads data that should be saved in the cache area 291 (for example, data for which command processing has been completed) from the volatile memory 29 and saves the data in the nonvolatile memory 28 as backup. That is, the controller 30 issues a write command including the data and a logical address and supplies the write command to the nonvolatile memory 28.

When receiving the write command, the nonvolatile memory 28 allocates a physical address to the logical address included in the write command. The nonvolatile memory 28 starts to write the data included in the write command in the physical address.

At timing t4, the rotation speed of the disk medium 11 starts to decrease and the regenerative energy received by the PLP regulator 42 from the SPM 12 starts to decrease. In response to this, the backup power supply power supplied from the PLP regulator 42 to the SVC 21 and the processor 26 starts to decrease.

At timing t5, when completing the writing of the data, the nonvolatile memory 28 returns a write completion notification to the controller 30. In response to the write completion notification, the controller 30 recognizes that the saving of the data in the nonvolatile memory 28 has been completed in response to the write command.

At timing t6, it is detected that the level of the backup power supply power drops to be equal to or lower than a threshold Pth2. In response to this, the PLP regulator 42 de-asserts the backup enable signal and provides the backup enable signal to the SVC 21 and the controller 30. The backup enable signal indicates that the backup (the saving) of the data should be ended in a de-asserted state.

In the PLP operation illustrated in FIG. 4, a required time T2 for data backup is required to fall within a period T1 in which data backup is possible.

For example, a write error sometimes occurs when the controller 30 writes data in the storage area of the nonvolatile memory 28. At this time, in the nonvolatile memory 28, when bad management unit processing (for example, bad block processing) for updating the defect management information 35 in response to performing rewrite a predetermined number of times and detecting a write error, it is likely that the required time T2 for data backup exceeds the backup power supply power usable period T1 to be long.

That is, it is likely that the data backup is not completed within the period T1, a part of data that should be saved in the cache area 291 (for example, data for which command processing has been completed) is discarded without being backed up, and data loss due to power supply cutoff occurs.

Therefore, in the present embodiment, in the disk device 1, the controller 30 enables efficient rewrite of data in the PLP operation by making it possible to execute alternative processing for alternatively re-address-designating, to another access unit, and rewriting data address-designated to a defective access unit among multiple access units (for example, multiple physical pages), each of which is smaller than a defect management unit (for example, a physical block).

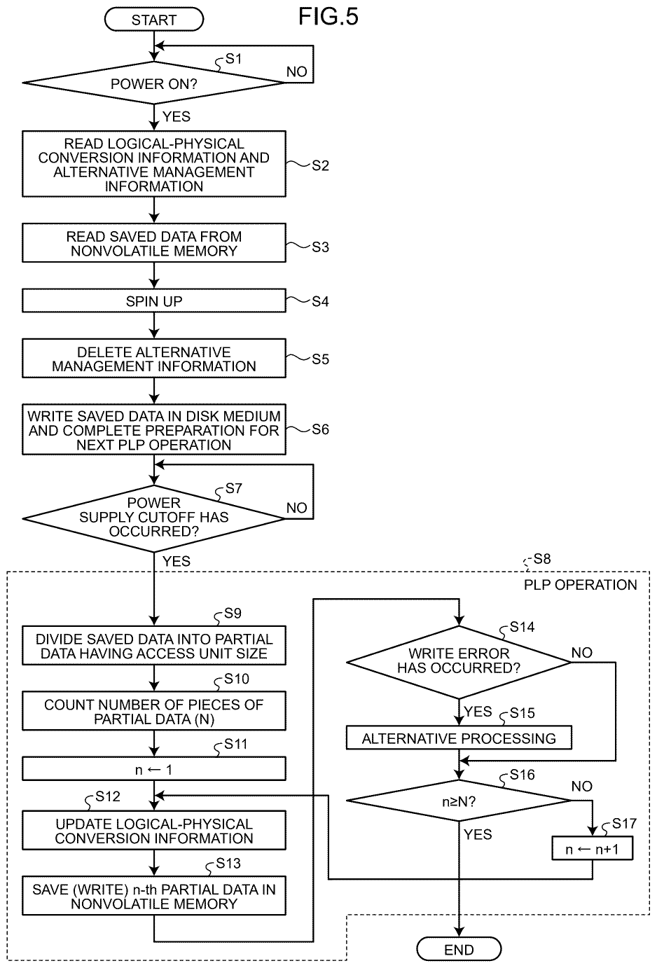

For example, the disk device 1 may perform an operation illustrated in FIG. 5. FIG. 5 is a flowchart illustrating a detailed operation of the disk device 1. In FIG. 5, an operation relating to power supply cutoff is illustrated.

In the disk device 1, the controller 30 waits until a power supply is turned on (No in S1).

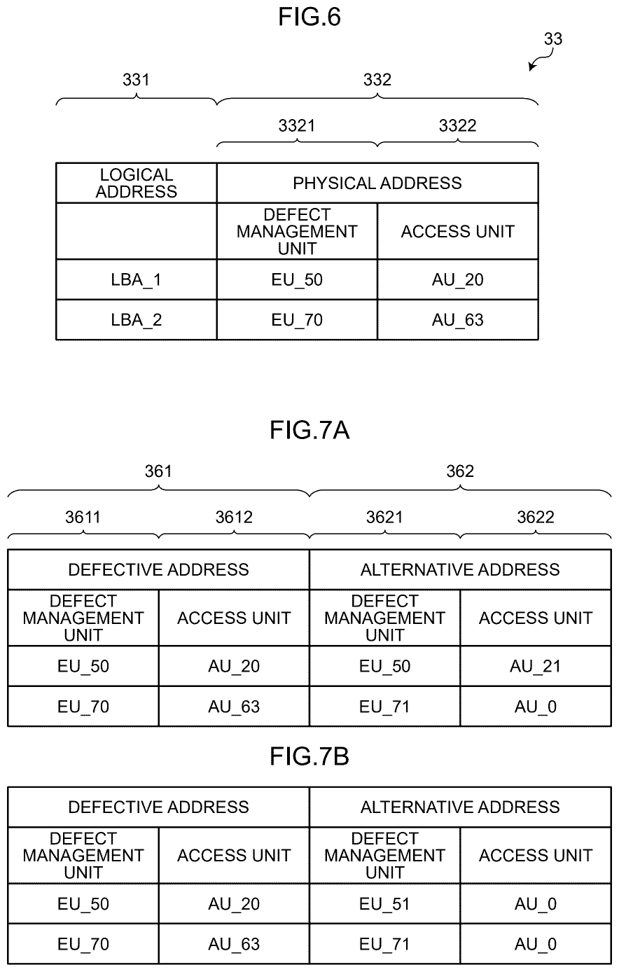

At this time, it is assumed that saved data by the last previous PLP operation is stored in the storage area 28a of the nonvolatile memory 28 and the logical-physical conversion information 32, the logical-physical conversion information 33 illustrated in FIG. 6, and the alternative management information 36 illustrated in FIG. 7A are stored in the nonvolatile memory 28 or the management information storage area of the disk medium 11 as management information of the last saved data. FIG. 6 is a diagram illustrating a data structure of the logical-physical conversion information 33. FIGS. 7A and 7B are diagrams illustrating a data structure of the alternative management information 36. In FIGS. 6 and 7A and 7B, a case in which each defect management unit EU includes sixty-four access units AU_0 to AU63 is exemplified.

In the logical-physical conversion information 32, for the saved data, a logical address and a physical address of the disk medium 11 are associated with respect to one or more logical addresses. By referring to the logical-physical conversion information 32, the controller 30 can grasp a logical address of the saved data and a physical address of the disk medium 11 that corresponds to the logical address and should originally be stored.

In a case where logical-physical conversion information 32 includes data other than the saved data, a flag indicating whether the data is the saved data may be associated in addition to the logical address and the physical address of the disk medium 11 with respect to one or more logical addresses. The controller 30 can selectively acquire a logical address of the saved data and a physical address of the disk medium 11 by referring to the flag.

In the logical-physical conversion information 33, for the saved data, a logical address and a physical address of the nonvolatile memory 28 are associated with respect to one or more logical addresses. The controller 30 can grasp a logical address of the saved data and a saving destination physical address corresponding to the logical address by referring to the logical-physical conversion information 33.

In a case where the logical-physical conversion information 33 includes data other than the saved data, a flag indicating whether the data is the saved data may be associated in addition to the logical address and the physical address of the nonvolatile memory 28 with respect to one or more logical addresses. The controller 30 can selectively acquire a logical address of the saved data and a physical address of the nonvolatile memory 28 by referring to the flag.

The logical-physical conversion information 33 may be implemented in a form of a table. The logical-physical conversion information 33 illustrated in FIG. 6 includes a logical address field 331 and a physical address field 332. The physical address field 332 includes a defect management unit address field 3321 and an access unit address field 3322. The defect management unit is, for example, a physical block. The access unit is, for example, a physical page of an MLC.

In the logical-physical conversion information 33, a logical address “LBA_1” in the logical address field 331 corresponds to a defect management unit “EU_50” +an access unit “AU_20” in the physical address field 332. Accordingly, it can be seen, by referring to the logical-physical conversion information 33, that data logically address-designated to the logical address “LBA_1” is written by being physically address-designated to the defect management unit “EU_50” +the access unit “AU_20”.

In the logical-physical conversion information 33, a logical address “LBA_2” in the logical address field 331 corresponds to a defect management unit “EU_70” +an access unit “AU_63” in the physical address field 332. Accordingly, it can be seen, by referring to the logical-physical conversion information 33, that data logically address-designated to the logical address “LBA_2” is written by being physically address-designated to the defect management unit “EU_70” +the access unit “AU_63”.

In the alternative management information 36, for the saved data, a physical address (hereinafter, a defective address) where a write error has been detected and a physical address (hereinafter, an alternative address) substituted for the physical address are associated with respect to one or more defective addresses. By referring to the alternative management information 36, the controller 30 can grasp which of physical addresses registered in the logical-physical conversion information 33 is a defective address and by which alternative address the defective address is substituted for. That is, the controller 30 can grasp a defective address and a physical address (an alternative address) substituted for the defective address by referring to the alternative management information 36.

In a case where the alternative management information 36 also includes data other than the saved data, a flag indicating whether the data is the saved data may be associated in addition to the defective address and the alternative address with respect to one or more defective addresses. The controller 30 can selectively acquire a defective address and an alternative address of the saved data by referring to the flag.

The alternative management information 36 may be implemented in a form of a table. The alternative management information 36 illustrated in FIG. 7A includes a defective address field 361 and an alternative address field 362. The defective address field 361 includes a defect management unit address field 3611 and an access unit address field 3612. The alternative address field 362 includes a defect management unit address field 3621 and an access unit address field 3622. The defect management unit is, for example, a physical block. The access unit is, for example, a physical page of an MLC.

In the alternative management information 36, a defect management unit “EU_50” +an access unit “AU_20” in the defective address field 361 correspond to a defect management unit “EU_50” +an access unit “AU_21” in the alternative address field 362. Accordingly, it can be seen, by referring to the alternative management information 36, that data address-designated to the defect management unit “EU_50” +the access unit “AU_20” is alternatively address-designated and rewritten to the defect management unit “EU_50” +the access unit “AU_21”.

In the alternative management information 36, a defect management unit “EU_70” +an access unit “AU_63” in the defective address field 361 correspond to a defect management unit “EU_71” +an access unit “AU_0” in the alternative address field 362. Accordingly, it can be seen, by referring to the alternative management information 36, that data address-designated to the defect management unit “EU_70” +the access unit “AU_63” is alternatively address-designated and rewritten to the defect management unit “EU_71” +the access unit “AU_0”.

Referring back to FIG. 5, when the power supply is turned on (Yes in S1), the controller 30 reads the logical-physical conversion information 32 and 33 and the alternative management information 36 from the nonvolatile memory 28 or the management information storage area of the disk medium 11 and stores the logical-physical conversion information 32 and 33 and the alternative management information 36 in the cache area 291 (S2).

The controller 30 reads the saved data from the nonvolatile memory using the logical-physical conversion information 32 and 33 and the alternative management information 36 (S3).

The controller 30 specifies a logical address of the saved data using the logical-physical conversion information 32 and the logical-physical conversion information 33. The controller 30 may specify a logical address of the saved data by extracting a logical address common to a logical address of the logical-physical conversion information 32 and a logical address of the logical-physical conversion information 33. The controller 30 refers to the logical-physical conversion information 33 and specifies a physical address of the nonvolatile memory 28 corresponding to the logical address of the saved data. The controller 30 refers to the alternative management information 36 for the specified physical address.

If the specified physical address is absent in the defective address field 361, the controller 30 reads saved data from the specified physical address and stores the saved data in the cache area 291.

If the specified physical address is present in the defective address field 361, the controller 30 specifies an alternative address corresponding to the physical address, reads saved data from the alternative address, and stores the saved data in the cache area 291.

The controller 30 starts spin-up control (S4). The controller 30 controls the SPM 12 to start rotating the disk medium 11. Accordingly, the rotation speed of the disk medium 11 starts to gradually rise.

In parallel with the spin-up control, the controller 30 deletes the alternative management information 36 (S5). The controller 30 accesses the cache area 291, deletes the alternative management information 36 temporarily stored therein, accesses the nonvolatile memory 28 or the management information storage area of the disk medium 11, and deletes the alternative management information 36 that is made nonvolatile.

When the rotation speed of the disk medium 11 stabilizes, the controller 30 writes the saved data in the disk medium 11. The controller 30 refers to the logical-physical conversion information 32 and specifies a physical address on the disk medium 11 corresponding to the logical address of the saved data. The controller 30 writes the saved data in the physical address on the disk medium 11. Accordingly, the controller 30 completes preparation for the next PLP operation (S6).

Note that the operations in S1 to S6 may be performed in a period before the timing t1 illustrated in FIG. 4.

The controller 30 waits until power supply cutoff occurs (No in S7).

When power supply cutoff occurs (Yes in S7), the controller 30 starts the PLP operation (S8). For example, the controller 30 may determine, according to the backup enable signal being asserted at the timing t2 illustrated in FIG. 4, that power supply cutoff occurs. In S8, S9 to S17 are performed.

In the PLP operation (S8), the controller 30 accesses the cache area 291 and acquires, as saved data, data in which command processing for a write request has been completed.

The controller 30 divides the saved data into partial data having an access unit size (S9) and counts the number of partial data (S10). The access unit size is, for example, a physical page size of the MLC. The number of pieces of partial data to be counted is set to N. N is any integer of 1 or more. The access unit size is smaller than a size of a defect management unit managed by the defect management information. The defect management unit is, for example, a physical block. The access unit is, for example, a physical page of an MLC.

The N pieces of divided partial data are referred to as first partial data, second partial data, . . . , and N-th partial data in order from the head side of the logical address.

The controller 30 sets 1 in a parameter n as an initial value (S11).

The controller 30 allocates a physical address to a logical address of the n-th partial data, registers a logical address and a physical address of an n-th access unit in the logical-physical conversion information 33, and updates the logical-physical conversion information 33 (S12).

The controller 30 saves (writes) the n-th partial data in the nonvolatile memory 28 (S13). The controller 30 issues a write command including the n-th partial data and physical address-designation allocated to the n-th partial data and supplies the write command to the nonvolatile memory 28. The physical address-designation may include a head physical address of an access unit allocated to the n-th partial data.

The controller 30 determines, for the n-th partial data, according to a response time to the write command, whether a write error has occurred (S14).

The controller 30 may include a timer 30a. The controller 30 measures the response time to the write command using the timer 30a. A threshold for the response time may be set in advance in the controller 30. The threshold is experimentally determined in advance according to a write command processing time corresponding to an access unit. The access unit is, for example, a physical page of the MLC, and the threshold is, for example, 0.7 ms. The timer 30a starts measuring the response time at timing when the controller 30 supplies the write command to the nonvolatile memory 28, finishes measuring the response time at timing when a response is returned from the nonvolatile memory 28, and notifies the response time to the controller 30. The controller 30 compares the response time with the threshold and can determine whether the response time is equal to or shorter than the threshold.

In a case where the response time from the nonvolatile memory 28 to the write command is equal to or shorter than the threshold, the controller 30 determines that a write error has not occurred (No in S14) and skips S15. The response time from the nonvolatile memory 28 to the write command being equal to or shorter than the threshold includes a response being received and a response time being equal to or shorter than the threshold.

In a case where the response time from the nonvolatile memory 28 to the write command exceeds the threshold, the controller 30 determines that a write error has occurred (Yes in S14) and determines that the access unit is a defective access unit. The response time from the nonvolatile memory 28 to the write command exceeding the threshold includes a case where response is absent and a case where response is received but a response time is longer than the threshold.

In response to this, the controller 30 performs alternative processing (S15). In the alternative processing, the controller 30 alternatively re-addresses, to another access unit, and rewrites partial data address-designated to a defective access unit.

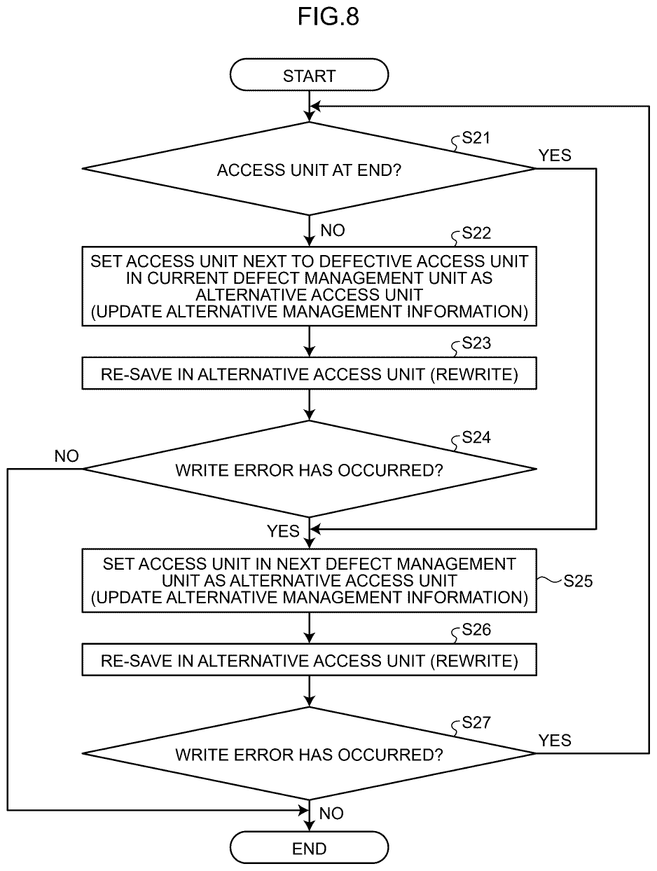

In the alternative processing (S15), S21 to S27 as illustrated in FIG. 8 may be performed. FIG. 8 is a flowchart illustrating the alternative processing.

In the alternative processing (S15), if the defective access unit is an access unit at the end in a current defect management unit (Yes in S21), the controller 30 skips S22 to S24.

If the defective access unit is not an access unit at the end in the current defect management unit (No in S21), the controller 30 sets, as an alternative access unit, an access unit next to the defective access unit in the current defect management unit (S22) and updates the alternative management information 36 accordingly. For the n-th partial data, the controller 30 alternatively allocates a physical address of the next access unit to a physical address of the defective access unit. The controller 30 registers a pair of the physical address of the defective access unit and the physical address of the next access unit in the alternative management information 36 and updates the alternative management information 36.

For example, it is assumed that a physical address “EU_50”+“AU_20” is allocated to a logical address “LBA_1” of the n-th partial data in S12 and a pair of the logical address “LBA_1” and the physical address “EU_50” +“AU_20” is registered in the logical-physical conversion information 33 as illustrated in FIG. 6. In a case where it is determined in S14 that a write error has occurred in response to a write command issued with “EU_50”+“AU_20” being address-designated in S13, as illustrated in FIG. 7A, “EU_50”+“AU_20” is registered as a defective address in the defective address field 361 of the alternative management information 36.

In S22, the access unit “AU_21” next to a defective access unit “AU_20” in a current defect management unit “EU_50” is allocated to the n-th partial data as an alternative access unit. In response to this, as illustrated in FIG. 7A, “EU_50”+“AU_21” is registered in the alternative address field 362 of the alternative management information 36 as an alternative address for the defective address “EU_50”+“AU_20”.

The controller 30 re-saves (rewrites) the n-th partial data in the alternative access unit (S23).

For example, in a case where “EU_50”+“AU_21” is registered in the alternative address field 362 of the alternative management information 36 as the alternative address for the defective address “EU_50”+“AU_20”, the controller 30 issues a write command including the n-th partial data and designation of the alternative address “EU_50”+“AU_21” and supplies the write command to the nonvolatile memory 28.

The controller 30 determines, for the n-th partial data, according to a response time to the write command, whether a write error has occurred (S24).

In a case where the response time from the nonvolatile memory 28 to the write command is equal to or shorter than the threshold, the controller 30 determines that a write error has not occurred (No in S24), determines that the alternative address is not a defective address, and ends the alternative processing (S15). The response time from the nonvolatile memory 28 to the write command being equal to or shorter than the threshold includes a response being received and a response time being equal to or shorter than the threshold.

In a case where the response time from the nonvolatile memory 28 to the write command exceeds the threshold, the controller 30 determines that a write error has occurred (Yes in S24).

In a case where determining that the defective access unit in S14 is the access unit at the end (Yes in S21) or in a case where determining that the alternative access unit in S22 is a defective access unit (Yes in S24), the controller 30 sets an access unit in a defect management unit next to the current defect management unit as an alternative access unit (S25) and updates the alternative management information 36 accordingly. For the n-th partial data, the controller 30 alternatively allocates a physical address of an access unit (for example, a head access unit) in the defect management unit next to the current defect management unit to the physical address of the defect access unit in S14. The controller 30 registers a pair of the physical address of the defective access unit and the physical address of the access unit in the next defect management unit in the alternative management information 36 and updates the alternative management information 36.

For example, in S22, the access unit “AU_21” next to the defective access unit “AU_20” in the current defect management unit “EU_50” is allocated to the n-th partial data as an alternative access unit. In response to this, as illustrated in FIG. 7A, “EU_50”+“AU_21” is registered in the alternative address field 362 of the alternative management information 36 as an alternative address for the defective address “EU_50”+“AU_20”.

When a write error occurs in S24, in S25, a head access unit “AU_0” in the defect management unit “EU_51” next to the current defect management unit “EU_50” is allocated to the n-th partial data as a further alternative access unit. In response to this, as illustrated in FIG. 7B, “EU_51”+“AU_0” is overwritten and registered in the alternative address field 362 of the alternative management information 36 as an alternative address for the defective address “EU_50”+“AU_20”.

Alternatively, it is assumed that a physical address “EU_50”+“AU_63” is allocated to the logical address “LBA_2” of the n-th partial data in S12 and a pair of the logical address “LBA_2” and a physical address “EU_70”+“AU_63” is registered in the logical-physical conversion information 33 as illustrated in FIG. 6. In a case where it is determined that a write error has occurred in S14 in response to a write command issued with “EU_70”+“AU_63” being address-designated in S13, as illustrated in FIG. 7A, “EU_70”+“AU_63” is registered as a defective address in the defective address field 361 of the alternative management information 36.

For example, in S21, it is determined that “AU_63” is an access unit at the end in “EU_70” and, in S25, the head access unit “AU_0” in a defect management unit “EU_71” next to a current defect management unit “EU_70” is allocated to the n-th partial data as an alternative access unit. In response to this, as illustrated in FIG. 7A, “EU_71”+“AU_0” is registered in the alternative address field 362 of the alternative management information 36 as an alternative address for the defective address “EU_70”+“AU_63”.

The controller 30 re-saves (rewrites) the n-th partial data in the alternative access unit (S26).

For example, in a case where “EU_51”+“AU_0” is registered in the alternative address field 362 of the alternative management information 36 as an alternative address for the defective address “EU_50”+“AU_20”, the controller 30 issues a write command including the n-th partial data and designation of the alternative address “EU_51”+“AU_0” and supplies the write command to the nonvolatile memory 28.

Alternatively, in a case where “EU_71”+“AU_0” is registered in the alternative address field 362 of the alternative management information 36 as an alternative address for the defective address “EU_70”+“AU_63”, the controller 30 issues a write command including the n-th partial data and designation of the alternative address “EU_71”+“AU_0” and supplies the write command to the nonvolatile memory 28.

The controller 30 determines, for the n-th partial data, according to a response time to the write command, whether a write error has occurred (S27).

In a case where the response time from the nonvolatile memory 28 to the write command exceeds the threshold, the controller 30 determines that a write error has occurred (Yes in S27) and returns the processing to S21.

In a case where the response time from the nonvolatile memory 28 to the write command is equal to or shorter than the threshold, the controller 30 determines that a write error has not occurred (No in S27), determines that the alternative address is not a defective address, and ends the alternative processing (S15).

Referring back to FIG. 5, when a value of the parameter n has not reached N (No in S16), the controller 30 increments the value of the parameter n (S17) and performs S12 to S16 again.

When the value of the parameter n reaches N (Yes in S16), the controller 30 determines that saving of all pieces of partial data included in the saved data has been completed, completes the PLP operation (S8), and ends the processing.

Note that the operation in S8 may be performed within a required period T2 of the timings t3 to t5 illustrated in FIG. 4.

As described above, in the present embodiment, in the disk device 1, the controller 30 is configured to be able to execute alternative processing for alternatively re-address-designating, to another access unit, and rewriting data address-designated to a defective access unit among multiple access units (for example, multiple physical pages), each of which is smaller than a defect management unit (for example, a physical block). Accordingly, efficient data rewrite in the PLP operation can be implemented and the required time T2 for data backup can be easily made shorter than the backup power supply power usable period T1. Therefore, it is possible to avoid data loss due to power supply cutoff.

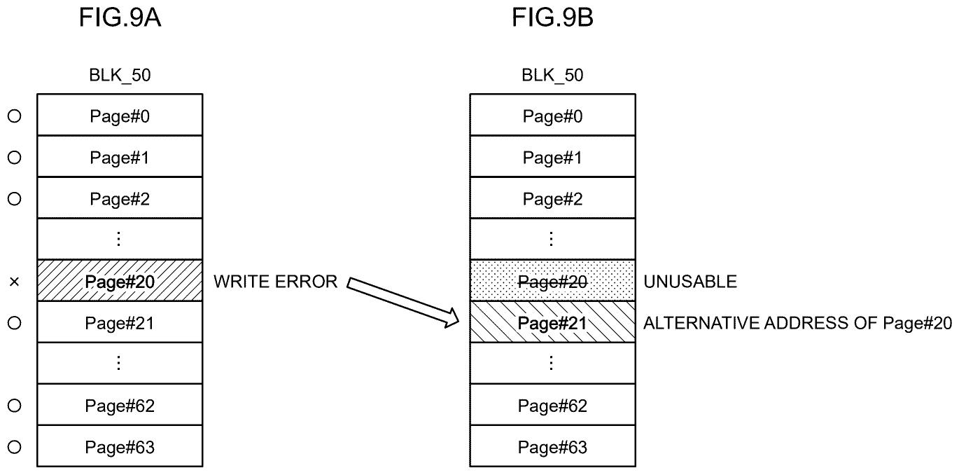

Note that, as a first modification of the embodiment, the disk device 1 may perform operations as illustrated in FIGS. 9A to 11C. FIGS. 9A to 11C are each diagrams illustrating use cases of the alternative processing (S15). In FIGS. 9A to 11C, a case in which a defect management unit is the physical block BLK and an access unit is the physical page Page of the MLC is exemplified. For example, in the configuration illustrated in FIG. 3, in the MLC, it is assumed that there are 4SU×9WL×2=72 physical page Page in one physical block BLK and, among the seventy-two physical pages Page, sixty-four physical page Page are allocated as a user area. The sixty-four physical pages Page are referred to as Page #0 to Page #64 in order from the head address side.

For example, it is assumed that a physical address “BLK_50”+“Page #20” illustrated in FIG. 9A is allocated to the logical address “LBA_1” of the n-th partial data in S12 (see FIG. 5) and a pair of the logical address “LBA_1” and the physical address “BLK_50” +“Page #20” is registered in the logical-physical conversion information 33. The n-th partial data is data of a physical page size. The physical address “BLK_50” +“Page #20” addresses a physical page. As illustrated in FIG. 9A, in a case where it is determined that a write error has occurred in S14 in response to a write command issued with “BLK_50”+“Page #20” being address-designated in S13, “BLK_50”+“Page #20” is registered as a defective address in the defective address field 361 of the alternative management information 36.

As illustrated in FIG. 9B, in S22 (see FIG. 8), a physical page “Page #21” next to the defective physical page “Page #20” in the current physical block “BLK_50” is allocated as an alternative physical page to the n-th partial data. In response to this, “BLK_50”+“Page #21” is registered in the alternative address field 362 of the alternative management information 36 as an alternative address for the defective address “BLK_50”+“Page #20”.

Thereafter, a write command including the n-th partial data and designation of the alternative address “BLK_50”+“Page #21” is issued and supplied to the nonvolatile memory 28. Accordingly, if no write error occurs, the saving of the n-th partial data in the alternative address “BLK_50”+“Page #21” is completed.

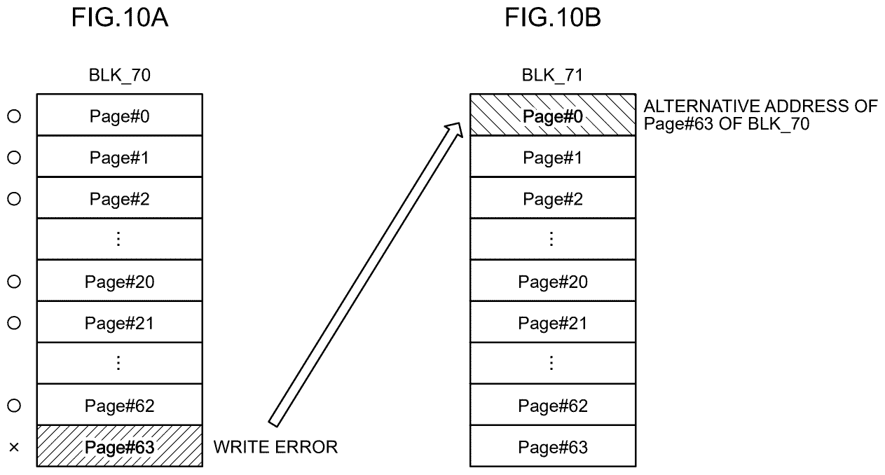

Alternatively, it is assumed that a physical address “BLK_50”+“Page #63” illustrated in FIG. 10A is allocated to the logical address “LBA_2” of the n-th partial data in S12 (see FIG. 5) and a pair of the logical address “LBA_2” and the physical address “BLK_50” +“Page #63” is registered in the logical-physical conversion information 33. As illustrated in FIG. 10A, in a case where it is determined that a write error has occurred in S14 in response to a write command issued with “BLK_50” +“Page #63” being address-designated in S13, “BLK_50” +“Page #63” is registered as a defective address in the defective address field 361 of the alternative management information 36.

In S21 (see FIG. 8), it is determined that “Page #63” is a physical page at the end in “BLK_70” and, in S29, a physical page “Page #0” in a physical block “BLK_71” next to the current physical block “BLK_70” is allocated to the n-th partial data as an alternative physical page. In response to this, “BLK_71”+“Page #0” is registered in the alternative address field 362 of the alternative management information 36 as an alternative address for the defective address “BLK_70”+“Page #63”.

Thereafter, a write command including the n-th partial data and designation of the alternative address “BLK_71”+“Page #0” is issued and supplied to the nonvolatile memory 28. Accordingly, if no write error occurs, the saving of the n-th partial data in the alternative address “BLK_71”+“Page #0” is completed.

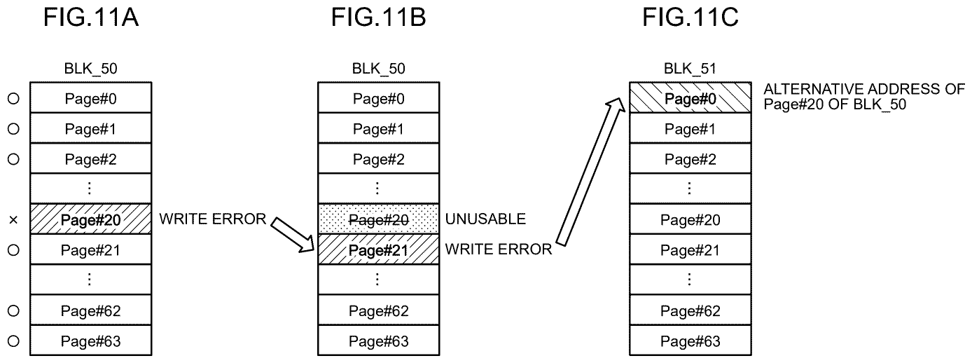

Alternatively, it is assumed that the physical address “BLK_50”+“Page #20” illustrated in FIG. 11A is allocated to the logical address “LBA_1” of the n-th partial data in S12 (see FIG. 5) and a pair of the logical address “LBA_1” and the physical address “BLK_50”+“Page #20” is registered in the logical-physical conversion information 33. In a case where it is determined that a write error has occurred in S14 in response to a write command issued with “BLK_50”+“Page #20” being address-designated in S13, “BLK_50”+“Page #20” is registered as a defective address in the defective address field 361 of the alternative management information 36 as illustrated in FIG. 11A.

In S22 (see FIG. 8), the physical page “Page #21” next to the defective physical page “Page #20” in the current physical block “BLK_50” is allocated to the n-th partial data as an alternative access unit. In response to this, as illustrated in FIG. 11B, “BLK_50”+“Page #21” is registered in the alternative address field 362 of the alternative management information 36 as an alternative address for the defective address “BLK_50”+“Page #20”.

When a write error occurs in S24, in S29, a head physical page “Page #0” in a physical block “BLK_51” next to the current physical block “BLK_50” is allocated to the n-th partial data as a further alternative physical page. In response to this, as illustrated in FIG. 11C, “BLK_51”+“Page #0” is overwritten and registered in the alternative address field 362 of the alternative management information 36 as an alternative address for the defective address “BLK_50”+“Page #20”.

Thereafter, a write command including the n-th partial data and designation of the alternative address “BLK_51”+“Page #0” is issued and supplied to the nonvolatile memory 28. Accordingly, if no write error occurs, the saving of the n-th partial data in the alternative address “BLK_51”+“Page #0” is completed.

In this way, in the disk device 1, the controller 30 is configured to be able to execute alternative processing for alternatively re-address-designating, to another physical page, and rewriting data address-designated to a defective physical page among multiple physical pages, each of which is smaller than a physical block. Accordingly, efficient data rewrite in the PLP operation can be implemented, and the required time T2 for data backup can be easily made shorter than the backup power supply power usable period T1. Therefore, it is possible to avoid data loss due to power supply cutoff.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A disk device comprising:
a nonvolatile memory including a storage area including multiple access units and a management information storage area in which defect management information is stored, each of the multiple access units being smaller than a defect management unit managed by the defect management information in the storage area; and
a controller accessible to the nonvolatile memory, the controller being configured to execute alternative processing by re-assigning data to another access unit and rewriting data originally assigned to a defective access unit among the multiple access units.

2. The disk device according to claim 1, wherein
the defect management unit includes a block, and
the access unit includes a page.

3. The disk device according to claim 1, wherein
the controller is configured to execute the alternative processing in response to occurrence of power supply cutoff.

4. The disk device according to claim 3, wherein
the controller generates or updates, according to the execution of the alternative processing, alternative management information in which an address of a defective access unit where a write error has been detected and an address of an access unit substituted for the address of the defective access unit are associated with respect to addresses of one or more defective access units.

5. The disk device according to claim 4, wherein
the controller stores the generated or updated alternative management information in the management information storage area and makes the generated or updated alternative management information nonvolatile.

6. The disk device according to claim 1, wherein
the controller is configured to issue a write command to the nonvolatile memory for each of the access units.

7. The disk device according to claim 6, further comprising
a host interface connectable to a host, wherein
in a case where a write request including address-designation concerning the multiple access units is received in the host interface from the host, the controller issues multiple write commands corresponding to the multiple access units to the nonvolatile memory in response to the write request.

8. The disk device according to claim 7, wherein
in a case where the write request is received, the controller divides write data included in the write request into multiple pieces of partial data each having an access unit size and issues the multiple write commands corresponding to the multiple pieces of partial data to the nonvolatile memory.

9. The disk device according to claim 7, wherein
in a case where a response time from the nonvolatile memory to a write command including address-designation of a first access unit exceeds a threshold, the controller determines that the first access unit is a defective access unit and reissues a write command including address-designation of a second access unit to the nonvolatile memory instead of the address-designation of the first access unit.

10. The disk device according to claim 9, wherein,
in a case where the response time from the nonvolatile memory to the write command including address-designation of the first access unit is equal to or shorter than the threshold, the controller determines that the first access unit is not a defective access unit.

11. The disk device according to claim 9, wherein
the nonvolatile memory includes a first defect management unit and a second defect management unit,
the first access unit and the second access unit are included in the first defect management unit, and
the second access unit is adjacent to the first access unit in the first defect management unit.

12. The disk device according to claim 9, wherein
the nonvolatile memory includes a first defect management unit and a second defect management unit,
the first access unit is included at an end of the first defect management unit, and
the second access unit is included at a head of the second defect management unit.

13. The disk device according to claim 9, wherein
in a case where a response time from the nonvolatile memory to the write command including address-designation of the second access unit exceeds the threshold, the controller determines that the second access unit is a defective access unit and reissues a write command including address-designation of a third access unit to the nonvolatile memory instead of the address-designation of the second access unit.

14. The disk device according to claim 13, wherein
the nonvolatile memory includes a first defect management unit and a second defect management unit,
the first access unit and the second access unit are included in the first defect management unit,
the second access unit is adjacent to the first access unit in the first defect management unit, and
the third access unit is included at a head of the second defect management unit.

15. A control method for a disk device, the disk device including a nonvolatile memory, the nonvolatile memory including a storage area, the storage area including multiple access units and a management information storage area, in the management information storage area defect management information being stored, each of the multiple access units being smaller than a defect management unit, the defect management unit in the storage area being managed by the defect management information, the method comprising:
issuing a write command including write data of a first access unit among the multiple access units and address-designation of the first access unit to the nonvolatile memory;
determining, according to a response of the write command, whether the first access unit is a defective access unit; and
in a case where the first access unit is a defective access unit, reissuing, to the nonvolatile memory, a write command including address-designation of a second access unit substituted for the first access unit.

16. The control method for the disk device according to claim 15, wherein the determining
includes, in a case where a response time of a write command including address-designating of the first access unit exceeds a threshold, determining that the second access unit is a defective access unit.

17. The control method for the disk device according to claim 16, wherein the determining
includes, in a case where the response time of the write command including the address-designation of the first access unit is equal to or shorter than the threshold, determining that the second access unit is not a defective access unit.

18. The control method for the disk device according to claim 15, wherein
the issuance is performed in response to occurrence of power supply cutoff.

19. The control method for the disk device according to claim 15, further comprising
generating or updating, according to the reissuance, alternative management information in which an alternative source and an alternative destination are associated with the first access unit set as the alternative source and with the second access unit set as the alternative destination.

20. The control method for the disk device according to claim 19, further comprising
storing the generated or updated alternative management information in the management information storage area and making the generated or updated alternative management information nonvolatile.
